(19) United States
(12) Patent Application Publication
(10) Pub. No.: US 2021/0262901 A1
(43) Pub. Date: Aug. 26, 2021

(54) Method for Quantitatively Evaluating Whole-field Lightweight Level of Structure Based on Fatigue Strength

(71) Applicant: UNIVERSITY OF SHANGHAI FOR SCIENCE AND TECHNOLOGY, SHANGHAI (CN)

(72) Inventors: XI LU, SHANGHAI (CN); JIAWEI HUANG, SHANGHAI (CN); HONG WANG, SHANGHAI (CN); HANGUANG LIU, SHANGHAI (CN); LEI TIAN, SHANGHAI (CN)

(73) Assignee: UNIVERSITY OF SHANGHAI FOR SCIENCE AND TECHNOLOGY, SHANGHAI (CN)

(21) Appl. No.: 17/057,669

(22) PCT Filed: Jul. 9, 2020
(86) PCT No.: PCT/CN2020/101043

§ 371 Date: Nov. 22, 2020

(30) Foreign Application Priority Data
Jul. 11, 2019 (CN) 201910623539.5

(51) Int. Cl. G01M 99/00

(52) U.S. Cl. CPC G01M 99/007; G01M 99/002

(57) ABSTRACT

To solve the problem of the incapacity of the prior method for evaluating a lightweight level based on fatigue strength to quantitatively evaluate a whole-field lightweight level of a mechanical structure and parts based on fatigue strength, the invention provides a method for quantitatively evaluating a whole-field lightweight level of a structure based on fatigue strength, characterized by matching a stress field of a structure with a fatigue strength field of the structure to quantitatively evaluate the whole-field lightweight level, specifically, by determining an ideal fatigue strength field distribution of a dangerous cross-section of the structure according to a maximum stress amplitude distribution of the dangerous cross-section, determining a fatigue strength distribution of the dangerous cross-section of the structure according to a static strength distribution requirement and a residual stress distribution of the dangerous cross-section, and applying a stress-strength interference model to quantitatively evaluate the whole-field lightweight level of the dangerous cross-section of the structure.

### TECHNICAL FIELD

The invention relates to the field of structural fatigue strength design and evaluation in mechanical structure design, suitable for fatigue strength design and evaluation of black, colored, and other metal mechanical structures and parts.

### BACKGROUND

According to the prior method for evaluating a lightweight level based on fatigue strength, the lightweight level based on fatigue strength is evaluated in the light of an overall strength viewpoint from which the fatigue strength of a mechanical structure and parts is regarded as a whole, only a relationship between the maximum stress amplitude of a dangerous cross-section and an overall fatigue strength is considered, and the maximum stress of a dangerous point is compared with the overall strength. The stress of a structure in a field shows inconsistency across local areas, a stress amplitude distribution of the dangerous cross-section of the mechanical structure and the parts in the whole field can be accurately solved through material mechanics or finite element calculations, and the stress amplitude of the dangerous cross-section of the mechanical structure and the parts varies at different positions under other types of loads than simple tensile and compressive loads. Therefore, the prior fatigue strength design method for the mechanical structure and parts can neither avoid local strength surplus of dangerous cross-sections, nor further quantitatively match materials, heat treatment and residual compressive stress influencing the fatigue strength of the dangerous cross-sections, incapable of quantitatively evaluating the whole-field lightweight level of the mechanical structure and parts based on the fatigue strength. A concept “strength field” is proposed in the invention to realize quantitative evaluation of the whole-field lightweight level by converting the stress field into an ideal fatigue strength field, determining a microstructural fatigue strength distribution of a dangerous cross-section of the structure according to a static strength distribution requirement, determining the fatigue strength distribution of the dangerous cross-section of the structure finally according to a residual stress distribution requirement of the dangerous cross-section, and quantitatively evaluating the whole-field lightweight level according to the relationship between a numerical ratio of the actual strength field to the stress field and a safety coefficient.

### SUMMARY OF THE INVENTION

The technical problem to be solved by the present invention lies in the incapacity of the prior method for evaluating a lightweight level based on fatigue strength to quantitatively evaluate a whole-field lightweight level of a mechanical structure and parts based on fatigue strength.

In order to solve the technical problem, the technical solution of the invention provides a method for quantitatively evaluating a whole-field lightweight level of a structure based on fatigue strength, characterized by matching a stress field of a structure with a fatigue strength field of the structure to quantitatively evaluate the whole-field lightweight level, comprising the steps of:

step 1, determining a structural dangerous position to be subjected to a quantitative evaluation of the whole-field lightweight level under a given maximum fatigue load amplitude value, to obtain a maximum stress amplitude value and a gradient distribution of stress amplitude values of a dangerous cross-section at the structural dangerous position;

step 2, determining an ideal fatigue strength field distribution of the structure according to the maximum stress amplitude and the gradient distribution of the stress amplitudes, wherein: the ideal fatigue strength distribution requires no strength surplus at any point and demand for strength is met; according to a stress-strength interference theory, an ideal strength at any point of the dangerous cross-section of the structure is designed as the fatigue stress amplitude at the point multiplied by a safety coefficient;

step 3, determining a microstructural fatigue strength distribution of the dangerous cross-section of the structure according to a static strength distribution requirement of the dangerous cross-section;

step 4, determining an actual fatigue strength distribution of the dangerous cross-section of the structure finally according to a residual stress distribution requirement of the dangerous cross-section of the structure, wherein: the residual stress distribution along a depth is contemplated quantitatively, the residual stress comprises residual compressive stress from cold strengthening, a residual tensile or compressive stress from heat treatment and processing, and the residual stress in structural stress fatigue is treated as average, with the residual compressive stress being negative, and the residual tensile stress being positive; and step 5, applying a whole-field stress-strength interference model to ensure that the strength at any point of the structure is greater than or equal to a maximum stress amplitude at the point, and carrying out the quantitative evaluation of the whole-field lightweight at the structural dangerous position through the actual fatigue strength distribution at the structural dangerous position determined in step 4 and the maximum fatigue stress amplitude distribution determined in step 1, namely, the quantitative evaluation of the lightweight level of surface and depth distributions thereof, to obtain a ratio of the actual fatigue strength at any point to the maximum stress amplitude at the point; finding that the actual fatigue strength is not enough and the fatigue strength design is unreasonable if the ratio of the actual fatigue strength at any point to the stress amplitude at the point is less than the safety coefficient; and finding that the strength at the point is surplus if the ratio of the actual fatigue strength at any point to the stress amplitude at the point is greater than the safety coefficient, a greater surplus corresponding to a greater ratio.

Preferably, in step 1, the structural dangerous position, the maximum stress amplitude and the gradient distribution of the stress amplitudes are obtained through material mechanics or finite element calculations.

Preferably, step 3 comprises the steps of:

targeting the ideal fatigue strength distribution of the dangerous cross-section, matching material of the structure with heat treatment, determining the microstructural fatigue strength distribution of the dangerous cross-section by using a hardness-tensile strength-fatigue strength conversion in conjunction with a minimum hardness distribution curve and a maximum hardness distribution curve of end quenching tests for the material, under the condition of satisfying the static strength distribution of the dangerous cross-section, so that the determined microstructural fatigue strength distribution and the ideal fatigue strength distribution intersect on the surface or are tangent to each other inside, avoiding a large area of structural fatigue strength surplus on the surface, a subsurface or in a core of the structure.

Compared with the prior method for evaluating a lightweight level, the invention is advantageous in that a quantitative lightweight evaluation is possible at any point of the whole field, so that the material utilization rate is further improved and the lightweight potential is fully exploited by upgrading the technique and material.

### BRIEF DESCRIPTION OF THE DRAWINGS

FIG. 1 is a flow chart of an implementation of the present invention;

FIG. 2 shows a fatigue tensile stress amplitude distribution and an ideal fatigue strength distribution;

FIG. 3 is an end quench curve for a 20 Cr material;

FIG. 4 is a preliminary microstructural fatigue strength distribution of a dangerous cross-section;

FIG. 5 shows a residual compressive stress distribution along a depth of a dangerous cross-section;

FIG. 6 shows a final fatigue strength distribution of a dangerous cross-section of a structure;

FIG. 7 is an evaluation of whole-field fatigue strength of the structure.

### DETAILED DESCRIPTION OF THE PREFERRED EMBODIMENTS

The invention will be further described with reference to the drawings. It should be understood that the embodiments are merely illustrative of the invention and are not intended to limit the scope of the invention. In addition, it will be understood that various changes and modifications may be made by those skilled in the art in light of the teachings of this invention, and these equivalents shall fall within the scope of the appended claims.

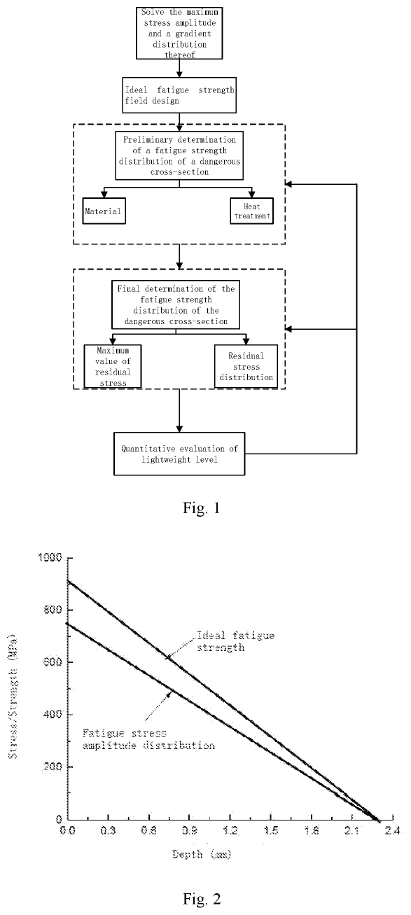

The invention is further illustrated by taking a single-tooth bending infinite fatigue strength design of a straight toothed spur gear as an example, wherein the material is 20Cr steel, subjected to the heat treatment (i.e., carburizing and quenching), having a surface hardness of 58-62 HRC, a core hardness of 30-42 HRC, a hardened layer with a depth of more than 0.70 mm. The surface of the gear is subjected to forced shot-peening, the maximum residual compressive stress is not less than 900 MPa, and it's required the single-tooth bending fatigue strength be such designed that cracks are initiated on a subsurface. As shown in FIG. 1, the invention provides a method for quantitatively evaluating a whole-field lightweight level of a structure based on fatigue strength, including the following steps.

1) Determination of the Maximum Stress Amplitude and a Gradient Distribution Thereof at a Dangerous Position of the Structure Under a Given Amplitude

Given the maximum fatigue load amplitude, the maximum stress amplitudes at the dangerous position and of the dangerous cross-section of the structure, as well as the gradient distribution of the stress amplitude are determined through material mechanics or finite element calculations.

For the single-tooth bending of the straight toothed spur gear, the finite element analysis is applied to arrive at the conclusion the dangerous position of the single-tooth bending is at a cross-section of a root of the gear when the given fatigue load amplitude is 7 kN, and the maximum stress occurs on the surface of the tooth root, being 752 MP. The gradient of the maximum stress amplitude is from the tooth root to a neutral layer along a direction of the load, and a fatigue tensile stress amplitudes distribution of the dangerous position is shown in FIG. 2.

2) Determination of an Ideal Fatigue Strength Distribution According to the Maximum Stress Amplitude and the Gradient Distribution Thereof

The ideal fatigue strength distribution of the requires no strength surplus at any point and demand for strength is met, a ratio of the ideal strength at any point of the dangerous cross-section of the structure to the fatigue stress amplitude of the point is a constant, the ideal fatigue strength field distribution of the structure can be determined according to the maximum stress amplitude and its gradient distribution of the dangerous cross-section. The strength is greater than the stress as per the stress-strength interference theory, the ratio of the ideal fatigue strength at any point of the dangerous cross-section of the structure to the fatigue stress amplitude at that point is a constant greater than 1, which is a safety coefficient. The ideal fatigue strength distribution on the dangerous cross-section of the structure has no strength surplus, and the strength utilization rate reaches the maximum.

In this embodiment, as required by the single-tooth bending infinite fatigue strength design of the straight toothed spur gear, the ideal fatigue strength is designed such that the ideal fatigue strength at any point of the dangerous cross-section of the structure is greater than the maximum stress amplitude at that point, the ratio of the ideal fatigue strength to the maximum stress amplitude is a constant, which is the safety coefficient related to factors such as discrete loads and material properties. Assigning 1.2 to the safety coefficient in this embodiment, and the ideal fatigue strength distribution of the dangerous cross-section along the depth is shown in FIG. 2.

3) Determination of the Microstructural Fatigue Strength Distribution of the Dangerous Cross-Section According to the Requirement of Static Strength Distribution of the Dangerous Cross-Section

The ideal fatigue strength distribution of the dangerous cross-section is targeted, a material of the structure is matched with heat treatment, the microstructural fatigue strength distribution of the dangerous cross-section is determined by using a hardness-tensile strength-fatigue strength conversion in conjunction with minimum and maximum hardness distribution curves of end quenching tests for the material, under the condition of satisfying the static strength distribution of the dangerous cross-section, so that the determined microstructural fatigue strength distribution and the ideal fatigue strength distribution intersect on the surface or are tangent to each other inside, thereby avoiding a large area of structural fatigue strength surplus on the surface, a subsurface or in a core of the structure.

In the embodiment, the material of the gear is 20 Cr steel, the heat treatment requires a surface hardness of 58-62 HRC, a core hardness of 30-42 HRC, and a hardened layer with a depth of more than 0.70 mm. The end quench curve of the material, as shown in FIG. 3, was first determined according to the heat treatment requirements of the gear.

By applying the corresponding relationship between hardness and tensile strength and the corresponding relationship between fatigue strength and tensile strength, a curve showing a preliminary microstructural fatigue strength distribution along the depth of the dangerous cross-section determined by the single-tooth bending microstructure can be obtained. For this embodiment, the relationship of the hardness-tensile strength-fatigue strength conversion is shown in Equation (1):

σ_{-1d}=0.3×(0.0176H_{d}^{2.88}+698) (1)

In Equation (1), σ_{-1d} is a symmetrical cyclic fatigue strength at depth d in the dangerous cross-section (MPa); σ_{b} is a tensile strength of the material (MPa); H_{d} is a HRC hardness at depth d in the dangerous cross-section.

Using Equation (1), the minimum and maximum curves of the fatigue strength determined by the single-tooth bending microstructure in this embodiment can be obtained, as shown in FIG. 4.

4) Final Determination of the Fatigue Strength Distribution of the Dangerous Cross-Section of the Structure According to the Residual Stress Distribution Requirement for the Dangerous Cross-Section

The residual stress distribution along a depth is also contemplated quantitatively for the fatigue strength distribution of the dangerous cross-section of the structure, the residual stress includes a residual compressive stress from cold strengthening, and a residual tensile or compressive stress from heat treatment and processing. The residual stress in structural stress fatigue is treated as average, with the residual compressive stress being negative, and the residual tensile stress is positive.

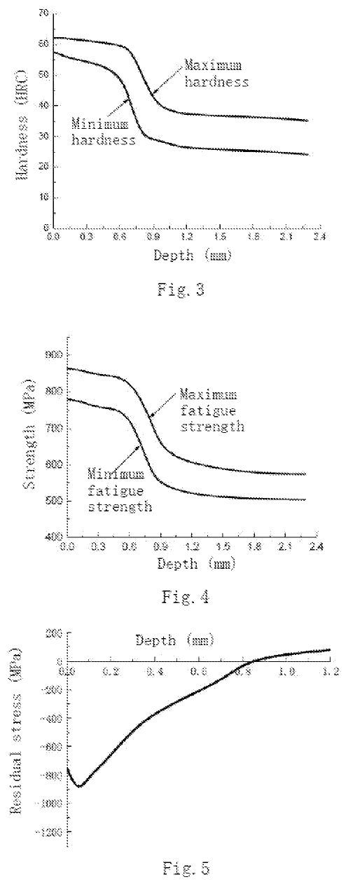

For the embodiment, the surface of the gear is shot-peened, the residual compressive stress on the surface is more than 700 MPa, the maximum residual compressive stress at a depth of about 0.05 mm in the subsurface exceeds 900 MPa, the residual compressive stress drops sharply at a depth more than 0.2 mm, and the residual compressive stress distribution of the dangerous cross-section of the tooth root along the depth is shown in FIG. 5.

The residual stress is treated as average, and the final fatigue strength with the residual stress considered is calculated according to Goodman Method in the embodiment. With the residual compressive stress considered, the fatigue strength of single-tooth bending is changed to σ₋₁_{^{d}}:

σ₋₁_{^{d}}′=[1−(σ_{sd}/σ_{b})] (2)

In Equation (2): σ₋₁_{^{d}}′ is the fatigue strength at depth d in the tooth root with the residual stress considered (MPa); σ_{-1d} is the microstructural fatigue strength at depth d in the tooth root (MPa); σ_{sd} is the stress distribution at depth d in the tooth root (MPa);

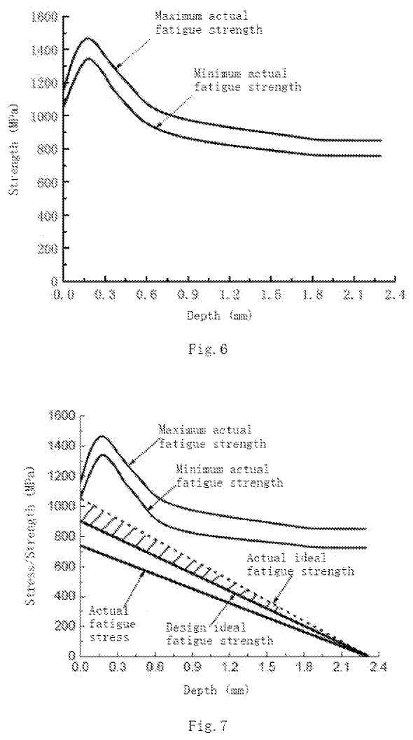

Using Equation (2), the curves for the minimum and maximum actual fatigue strength of single-tooth bending in this embodiment can be obtained, as shown in FIG. 6.

5) Quantitative Evaluation of the Whole-Field Lightweight Level of the Dangerous Cross-Section by Using a Stress-Intensity Interference Model

A whole-field stress-strength interference model, i.e., the strength design, is applied to ensure that the strength at any point is greater than or equal to a maximum stress amplitude at the point, and the quantitative evaluation of the whole-field lightweight at the structural dangerous position (i.e., the quantitative evaluation of the lightweight level of surface and depth distributions thereof) is carried out through the actual fatigue strength field distribution at the structural dangerous position and the maximum fatigue stress amplitude distribution, to obtain a ratio of the actual fatigue strength at any point to the maximum stress amplitude at the point; the actual strength is not enough and the fatigue strength design is unreasonable if the ratio of the actual strength at any point to the stress amplitude at the point is less than the safety coefficient; and the strength at the point is surplus if the ratio of the actual strength at any point to the stress amplitude at the point is greater than the safety coefficient, a greater surplus corresponding to a greater ratio.

In the embodiment, the whole-field stress-strength interference model means that the strength at any point is greater than the stress amplitude, and the stress amplitude distribution and the actual strength distribution of the embodiment are shown in one coordinate as in FIG. 7. The relationship among the actual minimum fatigue strength, the fatigue stress amplitude and the ideal fatigue strength (i.e., the actual fatigue strength at any point against the actual fatigue stress and the ideal fatigue strength) can be seen from the drawing. The lightweight level at any point can be evaluated by the ratio of the actual strength at that point to the stress magnitude at the point. In the embodiment, the surface, a subsurface carburized layer at a depth of 0.7 mm, a subsurface quench-hardened layer at a depth of 1.2 mm and a neutral layer at a depth of 2.3 mm are evaluated.

In the case of the surface, the actual bending fatigue strength is 1054 MPa, the design ideal bending fatigue strength is 902 MPa, and the actual bending fatigue stress amplitude is 752 MPa, then the ratio of the actual bending fatigue strength to the actual bending fatigue stress amplitude is 1.40, which is greater than the design safety coefficient 1.2 by 0.2, therefore the fatigue strength is not fully exploited and has certain lightweight potentials.

In the case of the subsurface carburized layer at a depth of 0.7 mm, The actual bending fatigue strength of is 950 MPa, the design ideal bending fatigue strength is 602 MPa, and the actual bending fatigue stress amplitude is 502 MPa, then the ratio of the actual bending fatigue strength to the actual bending fatigue stress amplitude is 1.89, which is greater than the design safety coefficient 1.2 by 0.69. Therefore, the fatigue strength surplus is serious, and the depth of the carburized layer is changed to render a lightweight strength design, so as to exploit the lightweight potentials.

In the case of the subsurface quench-hardened layer at a depth of 1.2 mm, the actual bending fatigue strength is 882 MPa, the design ideal bending fatigue strength is 420 MPa, the actual bending fatigue stress amplitude is 350 MPa, then the ratio of the actual bending fatigue strength to the actual bending fatigue stress amplitude is 2.52, which is greater than the design safety coefficient 1.2 by 1.32. Therefore, the strength surplus is obvious, the depth of the quench-hardened layer is changed to render a lightweight strength design, so as to exploit the lightweight potentials.

In the case of the neutral layer at a depth of 2.3 mm, the actual surface bending fatigue strength is 864 MPa, the design ideal bending fatigue strength and the actual bending fatigue stress amplitude are 0, the fatigue strength surplus at this point is infinite, and the core fatigue strength surplus can be reduced by using a hollow structure if allowable by the process conditions.

In the embodiment, the curves for the fatigue strength distribution and the fatigue stress amplitude distribution intersect at the surface as the fatigue stress amplitude increases. Since the fatigue strength of the surface is most dangerous with respect to the fatigue stress amplitude thereof, the ideal fatigue stress amplitude and the fatigue strength of the surface are subjected to the quantitative evaluation of the whole-field lightweight level, and the sub-surface and the core are determined by the material and the heat treatment characteristics of the material. The surface fatigue strength design requirement in the embodiment is 902 MPa, which is equivalent to a bending fatigue load of 8.4 kN; however, the actual fatigue strength can reach 1054 MPa, which is equivalent to the bending fatigue load of 9.8 kN. Therefore, the surface fatigue strength has a surplus of 152 MPa by 20%, indicating quite a lot of lightweight potentials.

1. A method for quantitatively evaluating a whole-field lightweight level of a structure based on fatigue strength, characterized by matching a stress field of a structure with a fatigue strength field of the structure to quantitatively evaluate the whole-field lightweight level, comprising the steps of:
step 1, determining a structural dangerous position to be subjected to a quantitative evaluation of the whole-field lightweight level under a given maximum fatigue load amplitude value, to obtain a maximum stress amplitude value and a gradient distribution of stress amplitude values of a dangerous cross-section at the structural dangerous position;
step 2, determining an ideal fatigue strength field distribution of the structure according to the maximum stress amplitude and the gradient distribution of the stress amplitudes, wherein: the ideal fatigue strength distribution requires no strength surplus at any point and demand for strength is met; according to a stress-strength interference theory, an ideal strength at any point of the dangerous cross-section of the structure is designed as the fatigue stress amplitude at the point multiplied by a safety coefficient;
step 3, determining a microstructural fatigue strength distribution of the dangerous cross-section of the structure according to a static strength distribution requirement of the dangerous cross-section;
step 4, determining an actual fatigue strength distribution of the dangerous cross-section of the structure finally according to a residual stress distribution requirement of the dangerous cross-section of the structure, wherein: the residual stress distribution along a depth is contemplated quantitatively, the residual stress comprises residual compressive stress from cold strengthening, a residual tensile or compressive stress from heat treatment and processing, and the residual stress in structural stress fatigue is treated as average, with the residual compressive stress being negative, and the residual tensile stress being positive; and
step 5, applying a whole-field stress-strength interference model to ensure that the strength at any point of the structure is greater than or equal to a maximum stress amplitude at the point, and carrying out the quantitative evaluation of the whole-field lightweight at the structural dangerous position through the actual fatigue strength distribution at the structural dangerous position determined in step 4 and the maximum fatigue stress amplitude distribution determined in step 1, namely, the quantitative evaluation of the lightweight level of surface and depth distributions thereof, to obtain a ratio of the actual fatigue strength at any point to the maximum stress amplitude at the point; finding that the actual fatigue strength is not enough and the fatigue strength design is unreasonable if the ratio of the actual fatigue strength at any point to the stress amplitude at the point is less than the safety coefficient; and finding that the strength at the point is surplus if the ratio of the actual fatigue strength at any point to the stress amplitude at the point is greater than the safety coefficient, a greater surplus corresponding to a greater ratio.

2. The method for quantitatively evaluating a whole-field lightweight level of a structure based on fatigue strength according to claim 1, characterized in that in step 1, the structural dangerous position, the maximum stress amplitude and the gradient distribution of the stress amplitudes are obtained through material mechanics or finite element calculations.

3. The method for quantitatively evaluating a whole-field lightweight level of a structure based on fatigue strength according to claim 1, characterized in that step 3 comprises the steps of:
targeting the ideal fatigue strength distribution of the dangerous cross-section, matching material of the structure with heat treatment, determining the microstructural fatigue strength distribution of the dangerous cross-section by using a hardness-tensile strength-fatigue strength conversion in conjunction with a minimum hardness distribution curve and a maximum hardness distribution curve of end quenching tests for the material, under the condition of satisfying the static strength distribution of the dangerous cross-section, so that the determined microstructural fatigue strength distribution and the ideal fatigue strength distribution intersect on the surface or are tangent to each other inside, avoiding a large area of structural fatigue strength surplus on the surface, a subsurface or in a core of the structure.
